(19) United States
(12) Patent Application Publication
(10) Pub. No.: US 2007/0175022 A1
(43) Pub. Date: Aug. 2, 2007

(54) VACUUM FIXTURE

(75) Inventor: Keng-Ming Chang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,607

(22) Filed: Aug. 30, 2006

(30) Foreign Application Priority Data
Oct. 28, 2005 (CN) 200510100804.X

(51) Int. Cl. B23P 19/00

(52) U.S. Cl. 29/743

(57) ABSTRACT

A vacuum fixture (100) for holding workpieces includes a case (10) formed with a hollow chamber (15), a plurality of suction cups (30) disposed on the case and a control valve (20). Each of the suction cups has an air aperture (33) in communication with the hollow chamber, and each of the suction cups serves to absorb a workpiece. The control valve serves to maintain and/or re-pressurize a vacuum in the hollow chamber.

### 1. FIELD OF THE INVENTION

The present invention relates generally to vacuum fixtures for holding workpieces and, more particularly, to a vacuum fixture for holding workpieces during a vacuum deposition process.

### 2. DESCRIPTION OF RELATED ART

Recently, various optical lenses have been used in camera modules which are received in portable devices, such as mobile phones, notebook computers, and portable digital assistants. The optical lenses are small enough to allow the miniaturization of the design of the portable devices. Further more, some optical films, such as anti-reflection coating, and infrared filter film, are usually formed on the surface of the lenses to meet some special optical requirements. During a vacuum deposition process for forming the optical films on the lenses, a conventional fixture for holding the lenses has a plurality of clamp members, which hold the lenses' edge. In the vacuum deposition process, particles may be applied to the surface of the lenses from any angle, however the clamp members can shield edges of the lenses, thus preventing some portions of the lenses from being coated. Therefore, coatings formed on the lenses can't achieve desired film uniformity. Some other fixtures have recesses formed thereon, which match with the lenses. The lenses are held in the recesses. However, the dimensions of the recesses are invariable, and the fixtures can only be used with their corresponding lenses. If the dimensions of the lenses are changed, the recesses of the fixtures need to be changed corresponding to the change of the lenses, thus increasing the cost of the vacuum deposition process.

What is needed, therefore, is a vacuum fixture, which is convenient for holding workpieces during a vacuum deposition process.

### SUMMARY OF THE INVENTION

In one embodiment thereof, a vacuum fixture for holding workpieces is provided. The vacuum fixture includes a case formed with a hollow chamber, a plurality of suction cups disposed on the case, and a control valve. Each of the suction cups has an air aperture in communication with the hollow chamber, and each of the suction cups serves to absorb a workpiece. The control valve serves to maintain and/or break a vacuum in the hollow chamber.

Other advantages and novel features will become more apparent from the following detailed description of preferred embodiments when taken in conjunction with the accompanying drawings.

### BRIEF DESCRIPTION OF THE DRAWINGS

Many aspects of the vacuum fixture can be better understood with reference to the following drawing. The components in the drawing are not necessarily drawn to scale, the emphasis instead being placed upon clearly illustrating the principles of the vacuum fixture. Moreover, in the drawing, like reference numerals designate corresponding parts throughout the several views.

FIG. 1 is a schematic view of a preferred embodiment of a vacuum fixture;

FIG. 2 is an exploded, perspective view of the vacuum fixture in FIG. 1;

FIG. 3 is a schematic view of a suction cup of the vacuum fixture in FIG. 1;

FIG. 4 is a schematic view of another visual angle of the suction cup in FIG. 1; and

FIG. 5 is an exploded, perspective view of another preferred embodiment of a vacuum fixture.

### DETAILED DESCRIPTION OF THE INVENTION

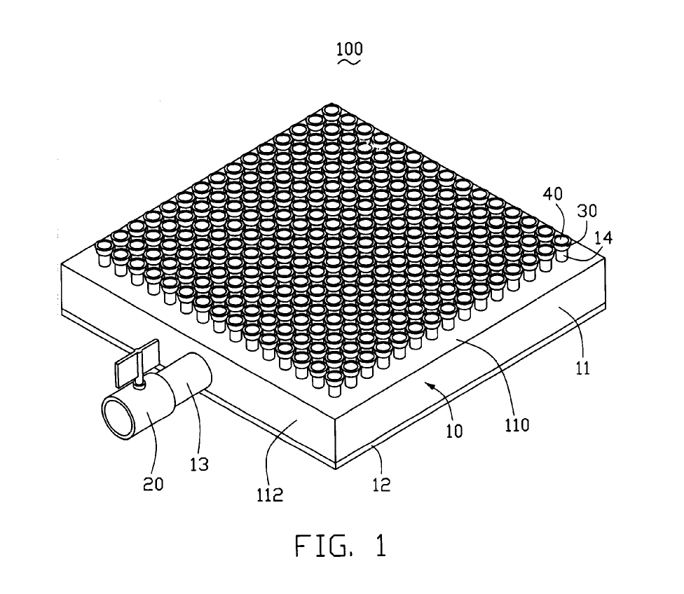

Referring to FIG. 1, in a preferred embodiment, a vacuum fixture 100 includes a case 10, a control valve 20 and a plurality of suction cups 30.

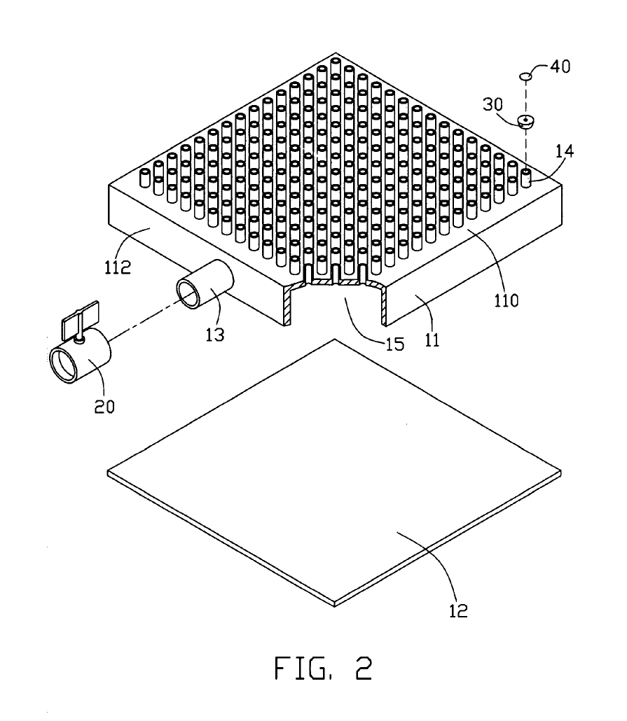

Referring to FIG. 2, the case 10 includes a main body 11, a bottom plate 12, and a tube 13. The main body 11 is provided with a top wall 110 and several sidewalls 112, which are integrally formed. The top wall 110 has several suction pipes 14 disposed thereon, which are arrayed in a matrix or a random arrangement. The sidewalls 112 are welded together with the bottom plate 12, thus defining a hollow chamber 15 between the top wall 110, the sidewalls 112 and the bottom plate 12. The tube 13 is disposed on one of the sidewalls 112. The suction pipes 14 and the tube 13 are in communication with the hollow chamber 15. The control valve 20 is a three-way valve. One end of the control valve 20 is connected to the tube 13, and the other end of the control valve 20 is connected to a vacuum pump, which serves to create a vacuum in the hollow chamber 15.

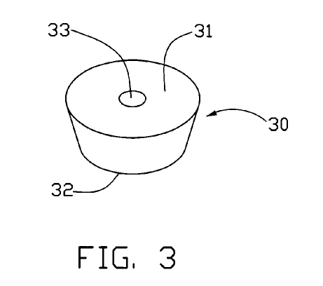

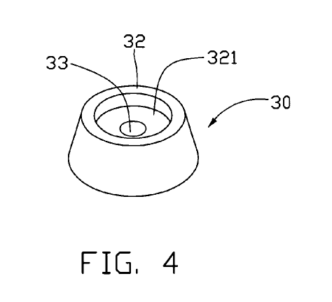

Referring to FIG. 3 and FIG. 4, the suction cups 30 are made of flexible plastic or rubber. Each of the suction cups 30 has an upper end 31, a lower end 32, and an air aperture 33 running through the upper end 31 and the lower end 32. The lower end 32 is provided with a recess 321. Each of the suction cups 30 is tightly mounted on a corresponding one of the suction pipes 14, with one end of the corresponding one of the suction pipes 14 being received in the recess 321, and with the air aperture 33 being in communication with the hollow chamber 15 via the corresponding one of the suction pipes 14.

In operation of the vacuum fixture 100, each of the suction cups 30 has a lens 40 seated on its upper end 31, with the lens 40 sealing the air aperture 33. The control valve 20 is turned on, and the vacuum pump is operated to evacuate air from the hollow chamber 15, thus creating a vacuum in the hollow chamber 15. Therefore, each lens 40 may be sucked against the surface of the upper end 31 of the corresponding one of the suction cups 30. The control valve 20 can be operated to block the communication between the vacuum pump and the hollow chamber 15, so that the vacuum in the hollow chamber 15 is maintained. The control valve 20 can be operated to repressurize the hollow chamber 15, so that the lens 40 can be easily removed from the vacuum fixture 100.

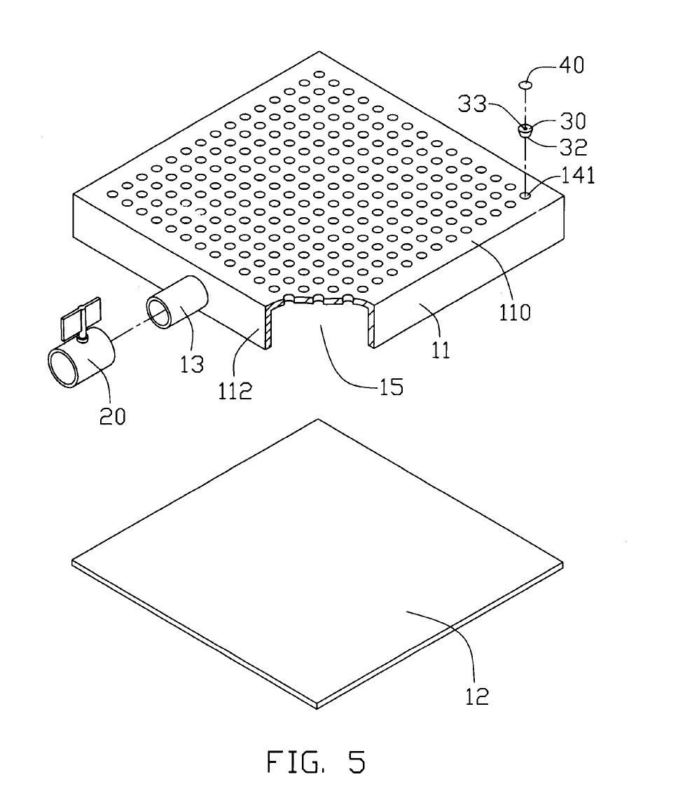

Referring to FIG. 5, in another preferred embodiment, the suction pipes 14 can be replaced with a plurality of openings 141, which are arrayed on the top wall 110 of the main body 11 in a matrix or a random arrangement and in communication with the hollow chamber 15. Each of the suction cups 30 is provided with the lower end 32 being tightly accommodated in and sealing one of the openings 141. The air aperture 33 is in communication with the hollow chamber 15. In operation, the lens 40 is seated on the upper end 31 and seals the air aperture 33, so that the lens 40 can be sucked against the upper end 31 when a vacuum is applied to the hollow chamber 15.

It should be understood, the suction cups 30 are cost-effective and easy to manufacture. When a dimension of the lens 40 is changed, new suction cups 30 fitting in the suction pipes 14 or the openings 141, with a modified dimension corresponding to the lens 40, are easy to rapidly applied.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A vacuum fixture for holding workpieces during a vacuum deposition process, comprising:
a case forming a hollow chamber therein;
a plurality of suction cups disposed on the case for absorbing workpieces, each of the suction cups having an air aperture being in communication with the hollow chamber, wherein the air aperture is closed by a corresponding workpiece when the workpiece is placed thereon; and
a control valve configured for maintaining and/or re-pressurizing a vacuum in the hollow chamber.

2. The vacuum fixture as claimed in claim 1, wherein the suction cups are made of rubber or flexible plastic.

3. The vacuum fixture as claimed in claim 1, wherein the case includes a main body and a bottom plate, the main body and the bottom plate are welded together, and the hollow chamber is formed between the main body and the bottom plate.

4. The vacuum fixture as claimed in claim 3, wherein the main body is provided with a top wall, the top wall has a plurality of suction pipes disposed thereon, each of suction pipes tightly engages with a corresponding one of suction cups.

5. The vacuum fixture as claimed in claim 4, wherein each of the suction cups has an upper end and a lower end, and the air aperture running through the upper end and the lower end.

6. The vacuum fixture as claimed in claim 5, wherein the lower end is provided with a recess, each of the suction cups is mounted on a corresponding one of the suction pipes, with one end of the corresponding one of the suction pipes being received in the recess.

7. The vacuum fixture as claimed in claim 3, wherein the main body is provided with a top wall, the top wall has a plurality of suction openings disposed thereon, and each of suction pipes tightly accommodates a corresponding one of suction cups therein.

8. The vacuum fixture as claimed in claim 7, wherein each of the suction cups has an upper end and a lower end, and the air aperture running through the upper end and the lower end.

9. The vacuum fixture as claimed in claim 8, wherein each of the suction cups is provided with the lower end being tightly accommodated in and sealing a corresponding one of the openings.
